(19) United States
(12) Patent Application Publication
(10) Pub. No.: US 2002/0133431 A1
(43) Pub. Date: Sep. 19, 2002

(54) Method for selling an article of jewelry

(76) Inventors: James West, Los Angeles, CA (US); Regina Powers, Reseda, CA (US); Gary Meyer, Rolling Hills Estates, CA (US); Alan Meltzer, Canton, OH (US); Alvin Daiches, Ft. Worth, TX (US); Amy Sachnoff, Sioux City, IA (US); John Jensen, Twin Falls, ID (US); Nate Morgan, Sandy, UT (US); Bart Marks, Reno, NV (US); Terry Call, Scottsdale, AZ (US); Donald Ritchie, Eugene, OR (US)

Correspondence Address: Daniel R. McClure, THOMAS, KAYDEN, HORSTEMEYER & RISLEY, L.L.P., Suite 1750, 100 Galleria Parkway, Atlanta, GA, 30339-5948, US

(21) Appl. No.: 09/813,688

(22) Filed: Mar. 19, 2001

(51) Int. Cl. G06F 17/60

(52) U.S. Cl. 705/27

(57) ABSTRACT

A method is described that enhances the atmosphere of romance that surrounds the purchase and delivery of a gift of jewelry. Broadly, the present invention establishes a romantic “theme” for a particular item of jewelry. This theme is first presented either through promotional advertising or in-store advertising, in connection with a particular item of jewelry. The theme is continued at the time of delivery of the item of jewelry, and is further continued even after the delivery. Preferably, this theme is in the form of a fabled love story, such as the stories of Romeo and Juliet, Orpheus and Eurydice, Tristan and Isolde, Anthony and Cleopatra, as well as countless others. It should be appreciated that such a novel method for selling an item of jewelry effectively enhances the atmosphere of romance that surrounds the gift, thereby enhancing the demand for jewelry items sold in this fashion. Preferably the method of one embodiment of the invention includes the step of providing a display in close proximity connection with the ring, wherein the display has a defined love story theme associated with it. The preferred method further includes the step of delivering the article of jewelry in a box, the box containing a miniature book having various love stories. Further still, the preferred method includes the step of providing a booklet containing a personalized poem, the booklet further including a graphic image that is associated with the love story theme.

### COPYRIGHT NOTICE

Portions of this patent application contain materials that are subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to jewelry sales and, more particularly, to a novel method for selling an article of jewelry.

### BACKGROUND OF THE INVENTION

The gift of diamonds and other fine jewelry surrounds many special occasions. Engagements, anniversaries, Mother's Day, Valentines Day, and birthdays, are just a few significant dates that are often celebrated with the gift of jewelry. The gift of a diamond or other fine jewelry between a man and a woman is a tangible means of expression, but the gift itself is typically just one component of an otherwise romantic event. With regard to diamonds, certainly the quality of the stone is very important. In this regard, many jewelers tout the “four c's;” namely, color, cut, carat, and clarity. In a way, the boasting of the four c's is a form of advertising, insofar as it gives the customer the impression that the particular jeweler is knowledgeable about diamonds. It also leads the customer to believe that the diamonds offered by that particular jeweler must be high quality, otherwise the jeweler would not be remarking on these aspects of the jewelry.

While customers certainly want to receive high-quality stones, they also generally seek to enhance the romance that surrounds the event that leads them to purchase the 5 diamond. To this end, many jewelers promote their products with slogans, such as “Diamonds are forever” and “Diamonds are a girl's best friend.” Although slogans like these are sometimes effective to lead a person to purchase jewelry for a loved one, or to lead a person to request a loved one to make such a purchase, they only marginally enhance the “romance” that surrounds the event of the gift.

Accordingly, it is desired to provide an improved method for selling jewelry that enhances the atmosphere of romance that surrounds the purchase and delivery of a gift of jewelry.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve the advantages and novel features, the present invention is generally directed to a novel method for selling jewelry. The method of the invention enhances the atmosphere of romance that surrounds the purchase and delivery of a gift of jewelry. Broadly, the present invention establishes a romantic “theme” for a particular item of jewelry. This theme is first presented either through promotional advertising or in-store advertising, in connection with a particular item of jewelry. The theme is continued at the time of delivery of the item of jewelry, and is further continued even after the delivery. Preferably, this theme is in the form of a fabled love story, such as the stories of Romeo and Juliet, Orpheus and Eurydice, Tristan and Isolde, Anthony and Cleopatra, as well as countless others. It should be appreciated that such a novel method for selling an item of jewelry effectively enhances the atmosphere of romance that surrounds the gift, thereby enhancing the demand for jewelry items sold in this fashion.

Preferably the method of one embodiment of the invention includes the step of providing a display in close proximity connection with the ring, wherein the display has a defined love story theme associated with it. The preferred method further includes the step of delivering the article of jewelry in a box, the box containing a miniature “book” of various love stories. Further still, the preferred method includes the step of providing a presentation folder containing a personalized love note, the folder further including a graphic image that is associated with the love story theme.

### BRIEF DESCRIPTION OF THE DRAWINGS

The accompanying drawings incorporated in and forming a part of the specification, illustrate several aspects of the present invention, and together with the description serve to explain the principles of the invention. The components in the drawings are not necessarily to scale, emphasis instead being placed upon clearly illustrating the principles of the present invention. Moreover, in the drawings, like reference numerals designate corresponding parts throughout the several views. In the drawings:

FIG. 1 is a flowchart illustrating certain steps in a method performed in accordance with an embodiment of the invention;

FIGS. 2A-2E are diagrams illustrating various displays that are used to promote articles of jewelry that are sold in accordance with a love story themes of the present invention;

FIG. 3A is a side view of a ring having a heart shaped insignia, which may be provided in accordance with one embodiment of the invention;

FIG. 3B is a view showing a portion of the inner diameter of the shank of a ring and an insignia that is provided thereon;

FIGS. 4A and 4B illustrate a decorative box that may be used to deliver and present an article of jewelry in accordance with one embodiment of the invention;

FIGS. 5A and 5B illustrate a presentation folder that contains a personalized love note and a certificate of authenticity that may be associated with an article of jewelry in accordance with one embodiment of the invention;

FIGS. 6A-6L are diagrams that illustrate a variety of personalized notes that may accompany the article of jewelry.

### DETAILED DESCRIPTION OF THE PREFERRED EMBODIMENT

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

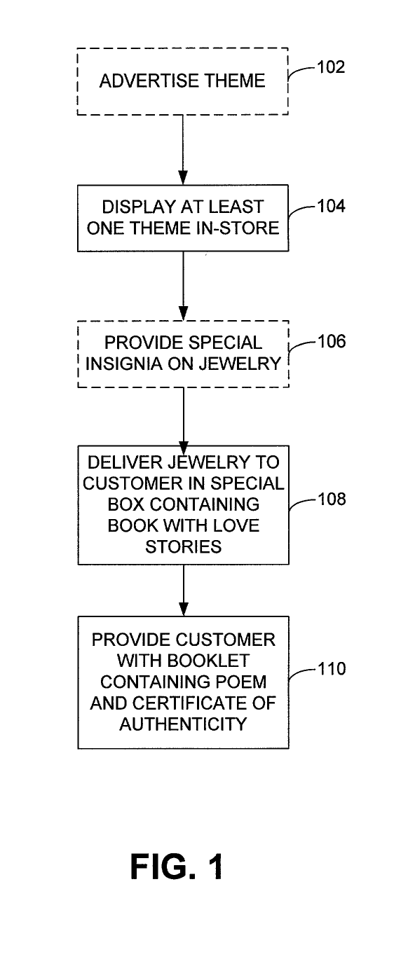

Reference is now made to FIG. 1, which shows a high-level flowchart of a novel method for selling items of jewelry in accordance with one embodiment of the present invention. In accordance with this embodiment, a first step in the novel method includes establishing a theme to be associated with an article of jewelry. Preferably, this theme centers around a fabled love story. To better establish an awareness of this theme, retailers and distributors of jewelry sold in accordance with the invention may advertise items of jewelry in accordance with this theme (step 102). Such advertising may be in the form of print advertising, radio advertising, television advertising, Internet advertising, and other methods and advertising which are customary in the trade. Such advertising may be performed in a variety of ways, but will preferably convey the enhanced atmosphere of romance that surrounds the delivery and gift of an article of jewelry in accordance with the novel method of the invention. In accordance with the scope and spirit of the present invention, a countless number and variety of fabled love stories may be provided to establish the theme associated with a given article of jewelry. However, only one theme will preferable be associated with any given article of jewelry. Several specific examples of such themes will be described in more detail below.

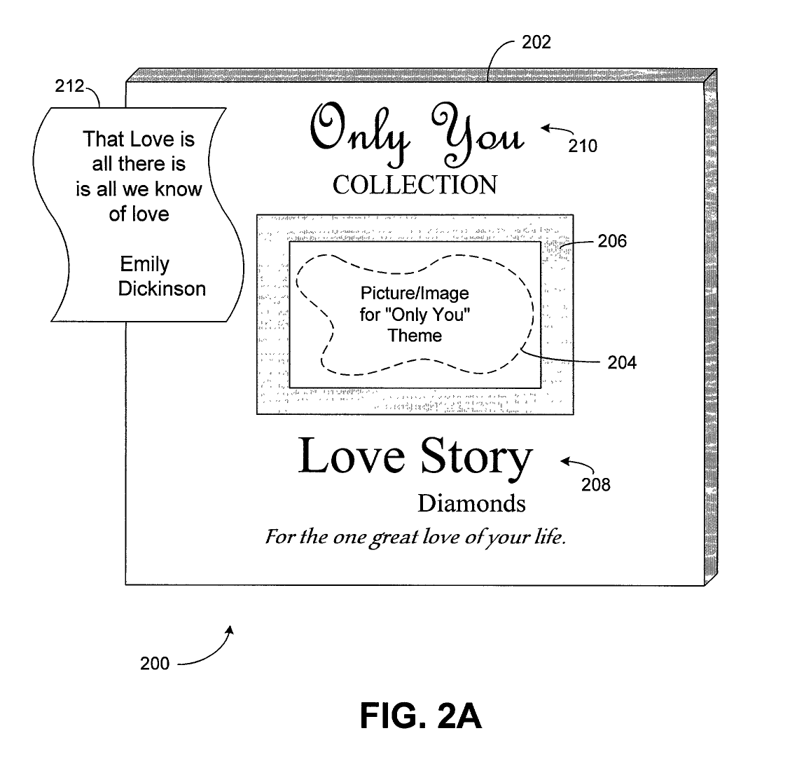

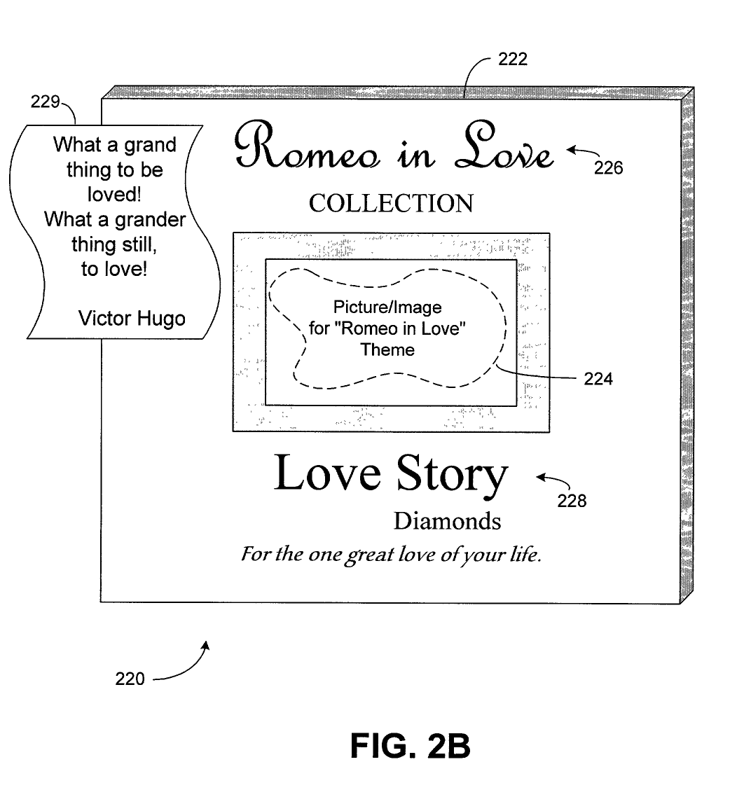

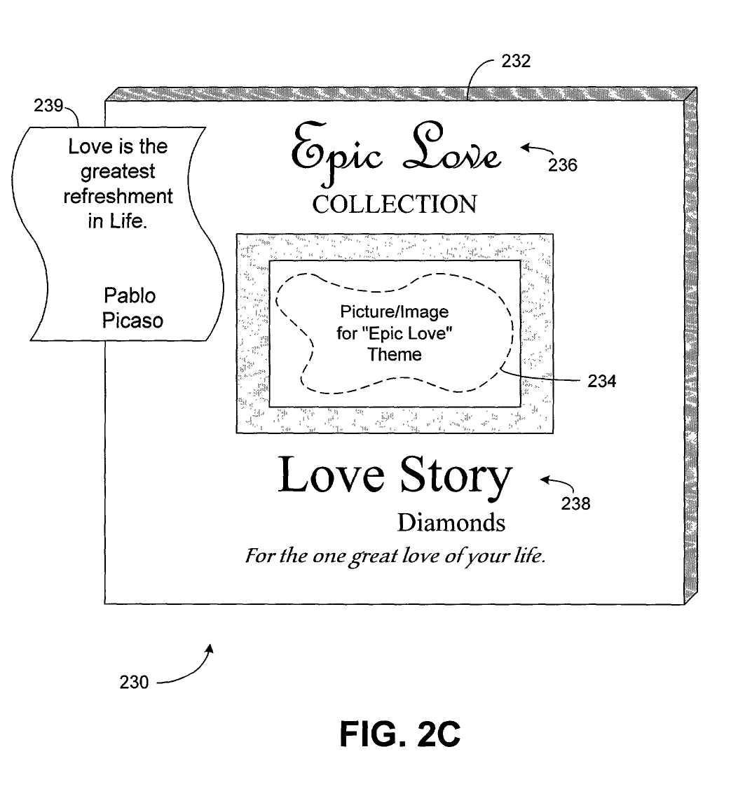

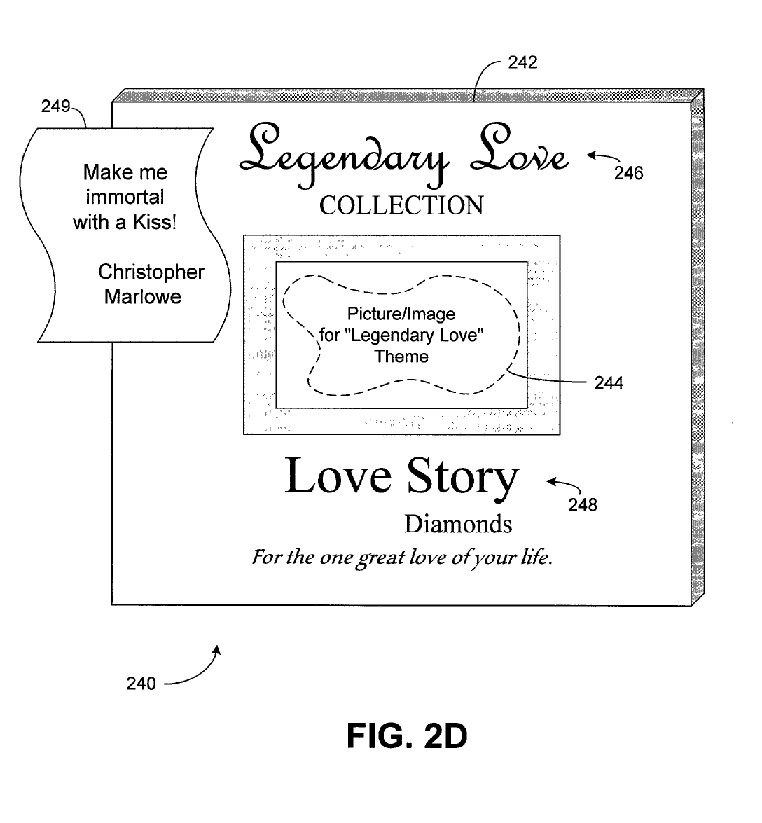

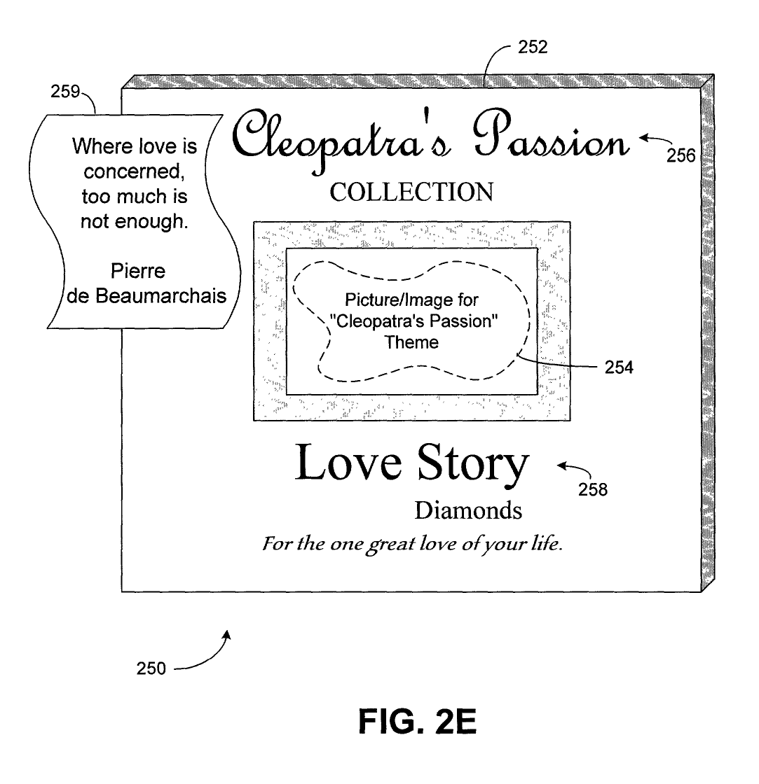

In accordance with the method of the preferred embodiment, in-store advertising may also be performed. Such in-store advertising may include the placement of visible displays in connection with various articles of jewelry (step 104). Specific examples of such displays will be described in connection with FIGS. 2A-2E. In addition, in-store displays may also include video and/or audio recordings for browsing customers to view and hear. In one embodiment, visible displays may be prominently displayed so that customers outside the store may be lured into the store. Such an approach would be particularly preferable in an environment (such as a shopping mall) where customers may shop by browsing from store to store.

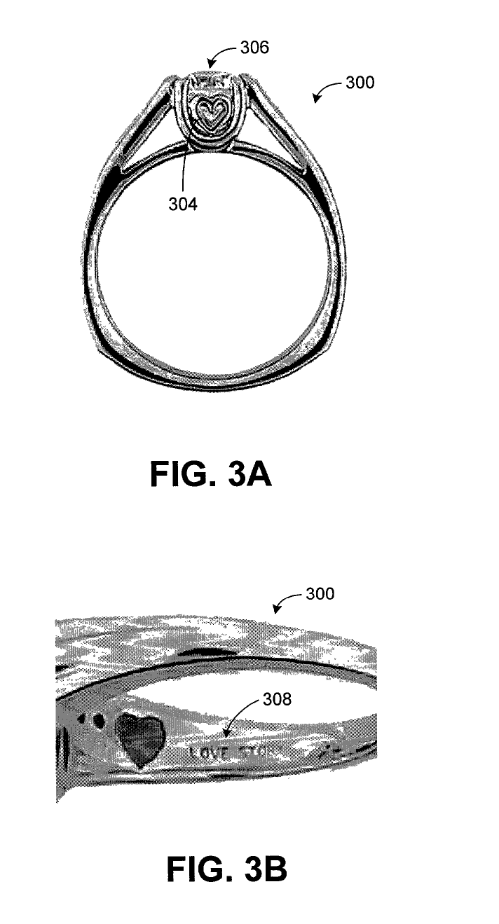

Items of jewelry that are sold in accordance with the preferred embodiment of the present invention may also bear one or more unique insignias that associate the articles of jewelry with the unique love story theme associated with that article of jewelry (step 106). In one embodiment, the insignia may be unique to the particular love story theme associated with that article of jewelry. More broadly, however, the generalized insignia may be provided on the articles of jewelry to associate the jewelry as being associated in a line of theme articles of jewelry. An illustration of such insignia will be described in more detail in connection with FIGS. 3A and 3B.

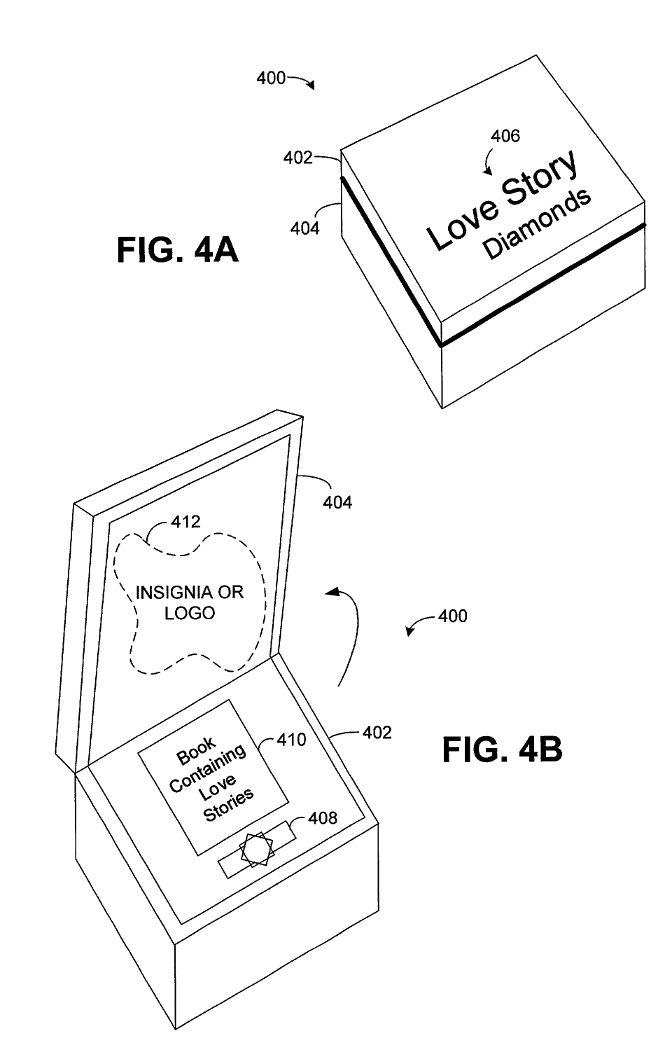

To further enhance the delivery and presentation of the article of jewelry, articles of jewelry sold in accordance with the method of the preferred embodiment are delivered in decorative boxes that include a small book containing various famous or fabled lover stories (step 108). An illustration of such a box will be described in more detail in connection with FIGS. 4A and 4B.

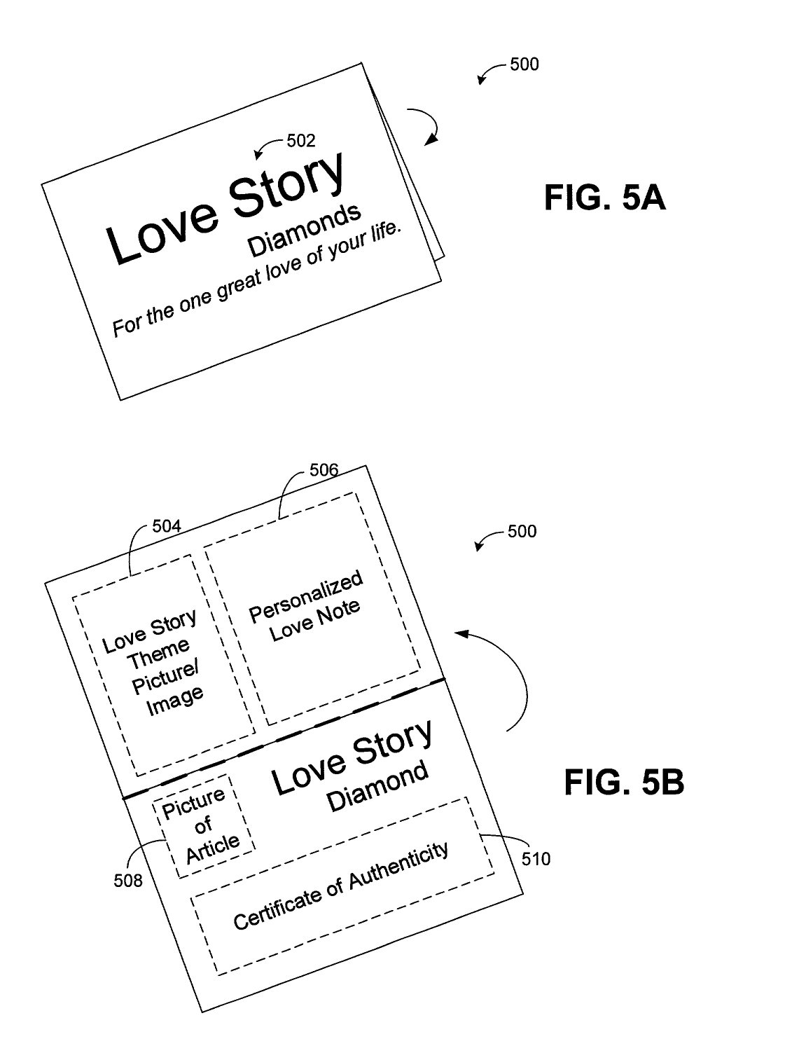

Finally, a presentation folder may be provided to accompany the article of jewelry, or alternatively may be provided after the sale. In the preferred embodiment, this folder contains a personalized love note, along with a certificate of authenticity for the particular article of jewelry (step 110). An illustration of such a presentation folder will be described in more detail in connection with FIGS. 5A and 5B.

In accordance with a broad concept of the preferred embodiment, a particular theme is established and associated with an article of jewelry. By establishing such a theme and presenting it in connection with a given article of jewelry in multiple instances, the romance that surrounds the event of the gift and delivery of the article of jewelry is effectively enhanced. As previously mentioned, consistent with the scope and spirit of the invention, countless themes may be utilized. Preferably, these themes are derived from fabled love stories. However, new and unique love stories may be crafted consistent with the invention. Indeed, certain customers may wish to write or create their own love stories, which may be personalized for the person who is the intended recipient of the article of jewelry. Accordingly, the present invention is not limited to any particular theme or themes. Notwithstanding, and to further illustrate the inventive concept, several themes will be described in detail herein.

In this regard, the themes described herein includes the story inspired by Claire de Lune (referred to as the “Only You” theme), the story of Romeo and Juliet (referred to as the “Romeo in Love” theme), the story of Orpheus and Euredice (referred to as the “Epic Love” theme), the story of Tristan and Isolde (referred to as “Legendary Love” theme), and the story of Anthony and Cleopatra (referred to as the “Cleopatra's Passion” theme).

In the preferred embodiment, a unique picture or graphic image has been developed to portray each unique theme. This same image may then be presented in several different stages of the purchasing and delivery process. Also, in the preferred embodiment, each of these fabled love stories has been artistically rewritten in a concise and unique fashion.

To further illustrate, reference is now made to FIG. 2A, which illustrates a display 200 that may be presented in connection with an article or articles of jewelry to be sold in connection with a first theme. Specifically, this figure illustrates a display 200 that may be provided in connection with the “Only You” theme. The display 200 preferably includes a frame 202 that artistically presents the unique picture or graphic image 204 that has been developed for the “Only You” theme. Preferably, the picture 204 is bordered or matted 206 within the frame for an enhanced aesthetic presentation. The title 210 of the theme is preferably displayed prominently near the top of the frame 202. In addition, a signature mark 208 is also preferably displayed near the bottom of the frame 202. This signature mark of the illustrated embodiment is “Love Story Diamonds.” Thereafter, when a customer sees this signature mark, the customer associates it with that article of jewelry (e.g., a diamond) that has been sold as a part of this signature collection. In addition, a romantic quote 212 may also be displayed in connection with the display 200. In the illustrated embodiment, the quote is “That Love is all there is is all we know of love” by Emily Dickinson.

Reference is now made to FIG. 2B, which illustrates a second display 220 that may be presented in connection with an article or articles of jewelry to be sold in connection with a second theme. Like FIG. 2A, this figure illustrates a display 220 that may be provided in connection with the “Romeo In Love” theme. The display 220 includes a frame 222 that artistically presents the unique picture or graphic image 224 that has been developed for the “Romeo In Love” theme. The title 226 of the theme is preferably displayed prominently near the top of the frame 222. In addition, the signature mark 228 is also preferably displayed near the bottom of the frame 222. In addition, the romantic quote 229 that is displayed in connection with the display 220 is the quote “What a grand thing to be loved! What a grander thing still to love!” by Victor Hugo.

Reference is now made to FIG. 2C, which illustrates a third display 230 that may be presented in connection with an article or articles of jewelry to be sold in connection with a third theme. Like FIG. 2A, this figure illustrates a display 230 that may be provided in connection with the “Epic Love” theme. The display 230 includes a frame 232 that artistically presents the unique picture or graphic image 234 that has been developed for the “Epic Love” theme. The title 236 of the theme is preferably displayed prominently near the top of the frame 232. In addition, the signature mark 238 is also preferably displayed near the bottom of the frame 232. In addition, the romantic quote 239 that is displayed in connection with the display 230 is the quote “Love is the greatest refreshment in Life.” by Pablo Picaso.

Reference is now made to FIG. 2D, which illustrates a fourth display 240 that may be presented in connection with an article or articles of jewelry to be sold in connection with a fourth theme. Like FIG. 2A, this figure illustrates a display 240 that may be provided in connection with the “Legendary Love” theme. The display 240 includes a frame 242 that artistically presents the unique picture or graphic image 244 that has been developed for the “Legendary Love” theme. The title 246 of the theme is preferably displayed prominently near the top of the frame 242. In addition, the signature mark 248 is also preferably displayed near the bottom of the frame 242. In addition, the romantic quote 249 that is displayed in connection with the display 240 is the quote “Make me immortal with a Kiss!” by Christopher Marlowe.

Reference is now made to FIG. 2E, which illustrates a fifth display 250 that may be presented in connection with an article or articles of jewelry to be sold in connection with a fifth theme. Like FIG. 2A, this figure illustrates a display 250 that may be provided in connection with the “Cleopatra's Passion” theme. The display 250 includes a frame 252 that artistically presents the unique picture or graphic image 254 that has been developed for the “Cleopatra's Passion” theme. The title 256 of the theme is preferably displayed prominently near the top of the frame 252. In addition, the signature mark 258 is also preferably displayed near the bottom of the frame 252. In addition, the romantic quote 259 that is displayed in connection with the display 250 is the quote “Where love is concerned, too much is not enough.” by Pierre de Beaumarchais.

Reference is now made to FIG. 3A, which is a side view illustrating a ring 300 having a unique insignia in accordance with one embodiment of the present invention. In the preferred embodiment, a heart-shaped insignia 304 is placed on at least one side of the ring 300. Preferably, the insignia 304 is located near the setting of the ring 300, just beneath the stone 306. Not only does the insignia enhance the aesthetic quality of the ring 300, but it also uniquely identifies the ring 300 as being an article of jewelry that is associated with a signature love story collection. The insignia 304 may be inscribed or otherwise disposed on one or both sides of the ring 300. Further, the insignia 304 need not be disposed only at the setting of the ring 300, but may be disposed in alternative locations as well. Further still, the insignia 304 need not be heart-shaped, but may be other shapes as well.

Reference is now made to FIG. 3B, which illustrates a portion of an inner diameter of the shank of the ring 300. In accordance with one embodiment of the invention, a special insignia 308 is placed in this location. In the preferred embodiment, this special insignia 308 includes a heart and the phrase “Love Story.” Like the insignia 304, the special insignia 308 also associates the ring 300 as being a part of the unique signature collection. It will be appreciated that in one embodiment of the invention, both insignias 304 and 308 may be provided on the ring 300. In an alternative embodiment, only insignia 304 is provided on the ring 300. In yet another embodiment, only insignia 330 is provided on the ring 300. In yet another embodiment, neither insignia is provided on the ring 300. Each of these various embodiments are consistent with the broader scope and spirit of the present invention.

Reference is now made to FIGS. 4A and 4B, which illustrate a unique presentation box or chest 400 that is used for storing the article of jewelry. The presentation box 400 is preferably an attractive keepsake that would be desired to be retained for storing the article of jewelry for years to come. Preferably the presentation box 400 includes a base 402 and a lid 404. The lid 404 may be hingedly attached along one side to the base 402, and may be adapted for movement between open and closed positions. In this regard, FIG. 4A illustrates the closed position while FIG. 4B illustrates an open position. The lid of the box 400 preferably includes the signature mark 406 that presented in connection with the displays of FIGS. 2A through 2E. Inside the presentation box is a compartment for holding and presenting the article of jewelry 408 (e.g., a diamond ring). A second contoured compartment may also be provided for holding a miniature book 410 that contains various love stories associated with the collections. Indeed, in one embodiment the miniature book 410 may include multiple love stories. In the preferred embodiment, a heart insignia or logo is displayed on the interior side of the lid 404 for enhanced aesthetic quality. In another embodiment, the unique picture or graphic image that is associated with the particular love story theme of the article of jewelry may be displayed on the interior side of the lid 404.

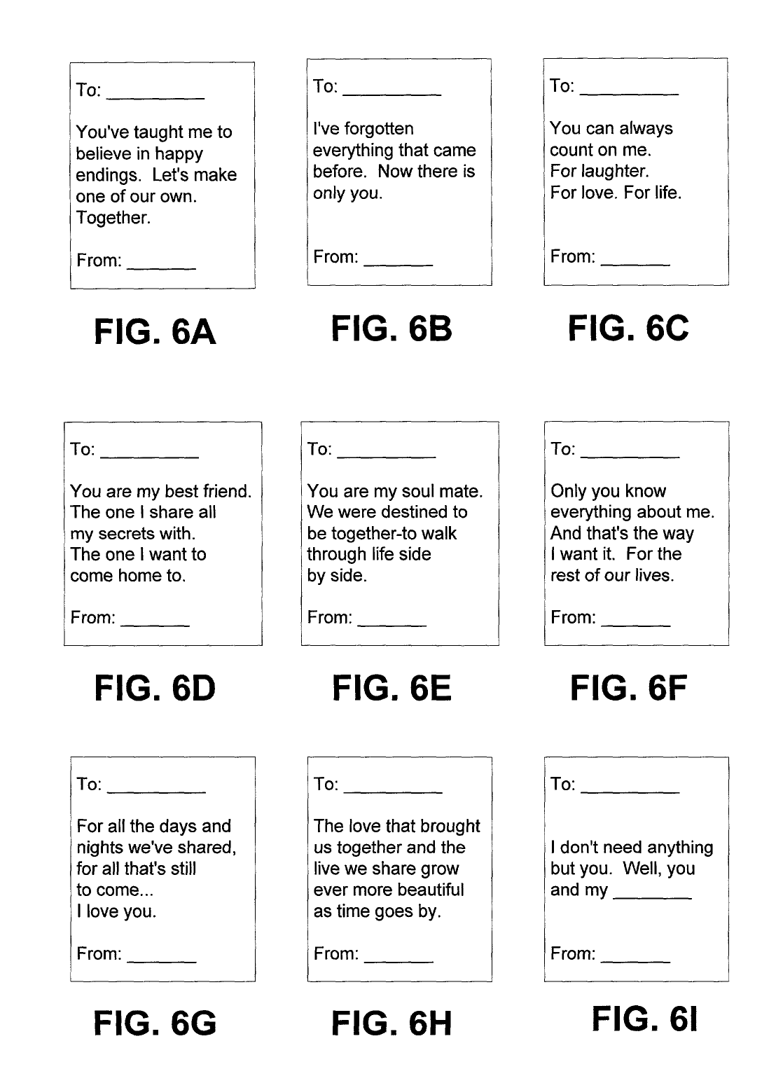

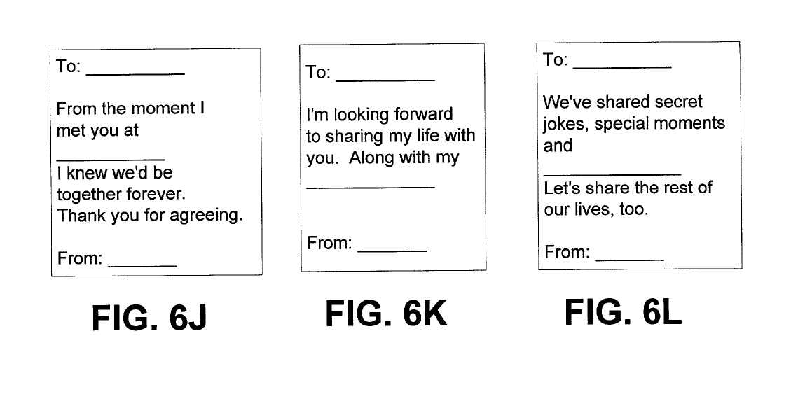

Reference is now made to FIGS. 5A and 5B. In connection with the preferred embodiment of the present invention, a presentation folder 500 is also provided in connection with the article of jewelry. Preferably, the folder 500 is an attractive, leather-bound bifold folder. The signature mark 502 may be displayed on the outside cover (FIG. 5A) of the booklet 500. Inside the booklet (FIG. 5B), however, other items are displayed to further enhance the atmosphere of romance surrounding the gift and/or delivery of the article of jewelry. These items may include the unique picture or graphic image 504 that is associated with the particular love story theme of the article of jewelry. In addition, a personalized love note 506 may be presented adjacent the picture 504. This personalized note or poem 506 may be uniquely crafted by the person purchasing the article of jewelry. Alternatively, then note or poem may be one selected from a plurality of previously written notes or poems. Examples of such previously written notes or poems are presented in FIGS. 6A through 6L. These include notes like “You've taught me to believe in happy endings. Let's make one of our own. Together.” (see FIG. 6A), “I've forgotten everything that came before. Now there is only you.” (FIG. 6B), and “You can always count on me. For laughter. For love. For life.” (FIG. 6C).

Consistent with the scope and spirit of the invention, however, numerous other pre-authored notes or poems may be provided. Further still, the purchaser may choose to modify any of the foregoing (or other) pre-authored poem or note, or draft on from scratch to craft a unique note personalized to the person to whom the article of jewelry will be given.

The booklet 500 may also include a photo or high-quality drawing 508 of the particular article of jewelry that has been purchased. Further still, the booklet 500 may also include a Certificate of Authenticity pertaining to the particular article of jewelry. As an example, such a certificate may state “This Love Story diamond wedding set from the ‘Romeo in Love’ Collection contains a 0.5 ct. round brilliant cut natural diamond VS1 clarity, J color. Set in a 14 kt. Gold mounting weighing approx. 3.2 dwt.” Such a certificate provides a technical description of the article and may be used for insurance and appraisal purposes.

It should be appreciated that there are a wide variety of various alternative configurations that may be utilized in connection with the unique and novel method described herein. Indeed, if the embodiments illustrated herein have illustrated the article of jewelry in the form of a diamond ring. It should be appreciated, however, at the unique method of the present invention applies equally to other types and articles of jewelry.

Having described certain features and aspects of various embodiments of the invention, reference is again made to the miniature book 410 illustrated in FIG. 4B. In the preferred embodiment, this book 410 contains at least one complete love story. Five different love story themes have been mentioned herein. The love story written in the book 410 is preferably a concise, abridged version of one of these fabled love stories. By way of non-limiting illustrations, an example of such an abridged version is presented below for each of the five fabled love stories mentioned herein. The invention is not to be limited to or by any of the illustrations presented below.

Romeo In Love

The Story of Romeo and Juliet By William Shakespeare

In the town of Verona lived two families, the Capulets and the Montagues, engaged in a bitter feud. Among the Montagues was Romeo, a hot-blooded lad with an eye for the ladies.

One day, Romeo was recounting for his friends his love for Rosaline, a haughty beauty from a well-to-do family. Romeo's friends chided him for his “love of love” but agreed to a plan to attend the feast of the Capulets', a costume party where Rosaline was expected to make an appearance. The disguises would provide Romeo and his friends a bit of sport and the opportunity to gaze undetected upon the fair Rosaline. Once there, however, Romeo's eyes fell upon Juliet, and he thought of Rosaline no more.

Asking around to learn the identity of Juliet, Romeo's voice is recognized by Tybalt, a member of the Capulet clan. Tybalt calls for his sword, but the elder Capulet intervenes, insisting that no blood be shed in his home. So Romeo is tolerated long enough to find an opportunity to speak to Juliet alone, still unaware of her identity.

He begs for an opportunity to kiss her hand. She relents. He presses his case, desiring her lips. She has no breath to stop him. Interrupted by the girl's nurse, Romeo learns the name of his heart's desire: Juliet Capulet.

The vision of Juliet now invades his every thought. Unable to sleep, Romeo returns late that night to the bedroom window of his love, hiding in the bushes below.

There, he is surprised to find Juliet on the balcony, professing her love for him and wishing that he were not a Montague.

O Romeo, Romeo! Wherefore art thou Romeo?

Deny thy father and refuse thy name . . .

What's a Montague? It is nor hand, nor foot,

Nor arm, nor face, nor any other part

Belonging to a man. O, be some other name!

What's in a name? That which we call a rose

By any other name would smell as sweet . . .

Romeo appears from the bushes, ready to deny his name and profess his love. The two agree to meet at nine o-clock the next morning to be married.

Early the next morning, Romeo appears at the cell of Friar Lawrence begging the friar to marry him to Juliet. Friar Lawrence does not take Romeo seriously at first, but he is soon impressed with Romeo's sincerity. The Friar agrees to perform the ceremony, praying that the union might someday put an end to the feud between the two households. Still, he advises Romeo keep the marriage a secret for a time. Romeo and Juliet are married.

On the way home, Romeo chances upon his friend Mercutio arguing with Tybalt in the public square. Spying Romeo, Tybalt tries to taunt him into a fight. Romeo has no desire to harm the kinsman of his new wife. Mercutio is stunned and embarrassed by Romeo's soft words and draws his sword. Romeo tries to restrain his friend, but Tybalt thrusts his sword underneath Romeo's arm, stabbing Mercutio. Tybalt then flees with his friends. The wound is worse than at first suspected. “Ask for me tomorrow,” says Mercutio, “and you shall find me a grave man.” He dies.

Tybalt returns still cursing the unexpectedly reluctant Romeo. But Romeo is reluctant no longer, drawing his sword and slaying Tybalt. The moment Tybalt falls, Romeo realizes he has made a terrible mistake: “O, I am fortune's fool!”

Desperate, Romeo rushes to Friar Lawrence who advises him to travel to Mantua until things cool down. He promises to inform Juliet.

Juliet receives the news of Tybalt's death and Romeo's exile. She dares not mention her marriage to her father now. Then, she receives more bad news. Her father has decided it is time for her to marry. He has selected a suitor: Paris, a kinsman of Mercutio.

Juliet, too, rushes to Friar Lawrence for counsel. The good Friar launches an elaborate plot. Juliet should agree to marry Paris. She will then take a sleeping potion, which will simulate death for three days. Her body will be placed in a tomb while she is mourned, and the Friar will send word to Romeo. Romeo will arrive in time to rescue her. The celebration over her return to life will provide an opportunity to explain about the marriage and the circumstances surrounding Tybalt's death.

The plot proceeds according to plan, and the wedding preparations for Paris and Juliet give way to solemn funeral arrangements. But the Friar's letter to Romeo fails to reach him before he hears of Juliet's death. Romeo obtains a poison from an apothecary and travels to Verona.

Under the cover of darkness, he breaks into Juliet's tomb. They are alone for only a moment. Paris, who also had come to mourn Juliet, interrupts, and believing Romeo to be a grave robber, draws his sword. The two men fight, and Paris is killed. Dying, Paris asks that his body be placed next to Juliet's. Only now recognizing Paris, the guilt stricken Romeo obliges.

Then Romeo kisses the lips of his Juliet one last time.

Eyes, look your last.

Arms, take your last embrace.

And, lips, O you the doors of breath,

Seal with a righteous kiss

A dateless bargain to engrossing death

Romeo thanks the apothecary for his skill and drinks the poison.

The effects of the sleeping potion wear off, and Juliet awakens calling for Romeo. Finding him next to her, dead, with a cup in his hand, she guesses what has transpired. She tries to kiss the poison from his lips, but failing that, unsheathes his dagger and plunges it into her breast.

Friar Lawrence learns that Romeo has not received his letter and rushes to Juliet's tomb to rescue her. He discovers the tomb already open and finds the sad contents within. Soon the Friar is joined by the Night Watchman, who had been alerted to the disturbance. Then the families gather around the star-crossed lovers. The Friar's mournful account of their death shames the two families into ending their feud forever.

Only You

The Story of Claire de Lune

The Duke of Picardy had dreamt of a woman so radiant that her beauty would not fade with the sun.

Late one evening, while out riding his steed, the Duke spotted Claire de Lune, a nymph, dancing in a meadow under the silver light of the moon. Enchanted, the Duke charged after her, but the wily nymph ran into the forest. Recklessly plowing through the tangled grove, the Duke collided with an overhanging tree branch, throwing him from his horse.

Undaunted, the Duke scrambled to his feet, chasing the fleeting glimpse of Claire's flowing gown. She seemed to disappear behind one tree trunk only to reappear from behind another. Still, the Duke followed.

Deep within the dark forest, the Duke found himself surrounded by nymphs, each possessing her own mysterious charms. But the Duke only had eyes for Claire. The other nymphs were rendered invisible to him, and the Duke found Claire, begging her to marry him.

At last, she relented, but only on the condition that he never question her or ask where she goes. Thoroughly bewitched, the Duke agreed.

The wedding night for the Duke and Claire was magical, and the magic continued night after night. Friends and servants of the Duke declared that they had never seen him so happy. But one evening, as the moon began to wane, the Duke awoke to find Claire was no longer with him. He cried out for her, but she did not answer.

In the ensuing days, he could think of nothing but her. He longed for her. Each night, he prayed for her return.

And just as a sliver of moon was reborn in the sky, the Duke felt a presence behind him. He turned to find his beloved Claire. He was so overjoyed to see her that he kept his promise not to question her. But the cycle continued, each month Claire disappearing with the waning moon only to reappear as the moon awakened in the sky.

The Duke grew increasingly disturbed by the pattern. Where was she going, he wondered? What was she doing? And with whom? He became convinced that she had found another lover. But how could he question her, for he remembered his promise. He vowed that he would not be made a fool of and settled upon a plan.

Under the gray light of the dying moon, the Duke only pretended to fall asleep. He followed Claire as she slipped away, keeping his distance so as not to arouse her suspicion. But it is not an easy thing to sneak up on a nymph in the forest. The Duke became lost in the darkness and growth, clawing his way through the strangling branches. At last he toppled down a steep ravine, injuring his ankle.

He tried to crawl out, but without hope of ever finding his way—or his Claire—he could muster no strength. He resigned to die then and there, cold and alone. But Claire pitied him. Taking him by the hand, she led him to the edge of the forest where she confronted him, crying out that he had ruined everything with his lack of faith. Then, she disappeared into the vapor.

The Duke made his way home, but could find no solace inside his great castle. He slept long and often, for in his dreams he was again with Claire. But when he awoke to find her missing, he wished he had not dreamed at all. He would take no food, nor strong drink. Soon, he could not find the strength to rise from his bed. His servants began making arrangements for his funeral. His friends and family divided up his possessions.

Then one evening, under the mock daylight of a blazing full moon, he heard the voice of his beloved singing in the forest. He could not see her, but he knew that it was Claire. The strength returned to his arms and legs, and he bounded from his bed racing into the forest, never to be heard from again.

Epic Love

The Story of Orpheus and Eurydice

Eurydice—wife of Orpheus, the greatest musician in all of Athens—tied from the bite of a snake. Orpheus found solace in his lyre, wringing from the instrument a melody so beautiful the whole world stilled to listen. Even the guardians at the gates of the underworld were lulled into a trance by the sweet music.

Orpheus walked passed the guardians, descending the spiral staircase into the bowels of the earth, his eyes stinging from the sulfurous smoke. Ghosts came thronging to the sound of his lyre, and the furies themselves were mesmerized. A vulture paused above the giant body of Tityus, no longer pecking at his liver. Sisyphus stopped to sit upon the rock he was condemned to push. Orpheus found Hades and his wife, Persephone, by the river Styxx. Hades was not amused.

“We don't get many visitors,” said the Lord of the Dead. His wife, Persephone—goddess of spring who spent half the year with her husband in Hell—was enchanted by the beautiful music. It reminded her of herself. She begged Hades to give the musician a chance to speak.

Orpheus said nothing, for his eyes had found Eurydice.

Persophone gathered his meaning and begged her husband to allow the two mortals to return to the surface. Hades had but one weakness. He was easily bored.

“One condition, Orpheus,” he said. “Don't look back.”

Orpheus and Eurydice ascended the great spiral staircase, their spirits lifting with each step. The light of living earth loomed in front of them. Eurydice squeezed Orpheus' hand. He looked back.

Her eyes registered the moment immediately, though it took a few moments for her body to be vaporized. Her sweet voice disappeared last. Orpheus stood alone on the surface of the world.

His lyre was less solace now, though the music was no less beautiful. He wanted only to be left alone in a barren rocky place, but his music lifted flowers from the craggy rocks. Trees bloomed. The hearts of the wild beasts were tamed. Fierce tigers lay down with cattle, wolves with sheep, eagles with trembling doves.

There were others enchanted by the sensuous music as well. Women of every variety flocked to Orpheus. He wanted nothing to do with any of them. He wanted only to treasure the memory of his lost Eurydice. Finally Orpheus was set upon by a pack of wild women who tore him limb from limb, tossing his head into a nearby stream.

His head bobbed out to sea, his cold tongue in his still gapping mouth calling out: “Eurydice! My poor Eurydice.”

Legendary Love

The story of Tristan and Isolde

In 780 A.D., in Ireland, a warrior prince by the name of Drust was born. His mother died during the ordeal, and so he became known as Tristan, from tristesse, meaning sorrow. How much of the rest of this story is true and how much belongs to the skill of the great Welsh troubadours no one really knows.

Tristan's father was a great knight, but Tristan never knew him. He died in a fight before Tristan was born. After the death of his mother, Tristan was taken to live with relatives in another land. He demonstrated an exceptional skill as a hunter at a very early age, but otherwise lived unremarkably until pirates kidnapped him at the age of 10. He managed to escape, but was swept away by the sea and washed up on the shore of a strange land. He made his way to a forest, where he survived by his incredible skill as a hunter.

Soon, rumors of a wild boy living in the woods began to spread. Tristan was captured and brought to the court of King Mark. A year later, a distant relative of King Mark's came to visit in search of the boy he had raised since birth. Shortly, Tristan was reunited with his guardian, but he decided to stay at the court of his uncle, King Mark, in hopes of becoming a knight.

Seven years later—having proved himself as the worthiest of the knights of King Mark—Tristan would face his greatest challenge. An enormous knight named Morold would be visiting soon. Every seven years, Morold would appear at the court of King Mark demanding a tribute of young men and girls. The tribute was always paid, since no champion dared to face Morold alone, and to tackle him any other way would be ignoble.

In Tristan, King Mark had finally found a hero unafraid, even zealous, to meet Morold.

The moment Morold felt the arm of Tristan, he knew he had met a man like no other he had known, but Morold fought on confidently. Before long, Tristan received a slight wound.

“I expected more from you,” said Morold.

“You expect this trickling of blood to stop me,” said Tristan.

“You'll feel the pain of your wound soon enough. This sword is not what it seems. Dipped in a poison of my own making. No one can cure you but my sister, Isolde, and you'll find no comfort there. Though we are different, my sister and I are two sides of the same coin, each the other's sworn protector.”

“Well then,” said Tristan, lunging, “I am not the only one who will die today.”

“The faster your blood races, the more the poison flows.”

“Then I will move quicker still.”

Tristan cracked the skull of Morold with his sword, then collapsed next to the fallen giant. Exhausted and already ill, Tristan was not yet ready to die. He knew of a Queen Isolde whose land was not far. Reasoning her to be the sister of Morold, he traveled to her castle disguised as a minstrel.

How Tristan survived the journey is impossible to say, but his magnificent body had grown haggard and weak by the time he arrived at the castle of Queen Isolde. Still, he managed to pull himself to his feet before the Queen and beg for an opportunity to speak. In a polite manner, he explained that he had been bitten by a snake and was dying. But he had heard of the sweet healing touch of the beautiful queen.

The Princess and the Queen were impressed by Tristan's fine manners, so noble for a minstrel on the verge of death. The Princess was assigned the task of nursing the boy back to health.

As Tristan's vigor returned, a palpable attraction to the Princess could be observed, which was a source of some concern for the Queen. A Princess, thought the Queen, should find better ways to occupy her time than consorting with minstrels.

Meanwhile, Tristan decided to send word back to King Mark informing his uncle of his improving condition. The very ideal of chivalry, Tristan was an accomplished musician and poet. Inspired by the unsurpassed beauty of Isolde, he constructed tender verses in her honor.

Moved by the gorgeous poetry, King Mark remembered his people's need for a queen. He sent word to Queen Isolde, who was thrilled by the prospect of her daughter's marriage to a powerful King. If the girl must waste her time toying with minstrels, let her do it as a well-married queen. But the Queen decided to keep her plans a secret, to surprise her daughter with the good news when the deal was set.

Then the body of Morold was brought back to the castle of Isolde. Upon seeing it, the Queen and the Princess vowed revenge upon “whomsoever did this heinous deed.” Avenging the death of Morold was the solemn duty of his relatives, a pact made by a priest at the birth of the Queen and her brother.

Preparing the body for burial, Princess Isolde noticed a small chunk of metal lodged in his skull. She removed it, hoping someday to use the evidence to discover his killer.

One afternoon, the Princess found Tristan's sword and noticed a piece of metal missing from it. Matching up the fragment taken from her uncle's skull, she realized, to her horror, that the killer was the fair minstrel she had grown so fond of—obviously no ordinary minstrel.

She had no choice. She must kill Tristan. But she could not bare the thought. She had grown so fond of the boy. She resolved to follow the only honorable course she could see; she would kill Tristan, then kill herself. She might be dead, but she would be well remembered.

She chose poisoned wine as the method. She informed only her loyal servant, Brangane, of the plot. But Brangane, whose duty would have been to commit suicide along with her mistress, considered love preferable to death and switched the poison crystals for the crystals of a love potion.

The Princess poured the crystal laden wine.

“Why so melancholy, Princess?” Tristan asked, his own spirits soaring.

“To fate,” she said, lifting her cup. They drank, unleashing an unrelenting passion, a love without care of consequences, without regard for any obstacle. Surely such emotions do not belong to crystals alone, but sparked by magic or fate, a seething insatiable love began to move inexorably towards its end, sweeping Tristan and Isolde along with it.

As the unsuspecting Tristan sipped his wine, the messengers of King Mark were speeding towards him with news of the King's impending nuptials—and Tristan's next assignment: to escort the King's new bride to her new home.

By elaborate scheme, Tristan and Isolde managed to avoid the wedding night horror of her in the bed of King Mark.

Rumors of a possible affair between the beautiful two had begun to trickle back to the ears of Mark. King Mark was said to possess “the ears of an ass,” perhaps suggesting “he heard all” or at least, didn't miss much. Suspicious, he decided to put Isolde to the test, a trial by fire. His young bride would swear her fidelity to him then place her hands on a red-hot iron. Her truthful words would protect her from the searing metal.

Attending the ordeal, Tristan disguised himself as a tattered pilgrim. Approaching the King, Isolde stumbled into the arms of the dusty palmer. When questioned, Isolde claimed no man had lain hands on her “save this poor pilgrim here.” She survived the ordeal unscathed.

Faithful Brangane took Isolde's place in King Mark's wedding bed. Brangane covered her face, claiming her purity and the traditions of her land required such modesty.

Resorting to all sorts of similar trickery, Tristan and Isolde yielded to their passions, but King Mark and his ears grew more and more alert. Once he found the two of them lying in a forest with a naked sword between them. Once he stabbed Tristan in the back with a knife while the boy composed a song for his fair queen. Tristan survived the wound, but Mark could stand no more of the rumors and banished him.

Recognizing his guilt, Tristan accepted his fate and set out to accomplish many great deeds in the name of King Mark and the fair queen Isolde. The fame of Tristan spread far and wide and he joined King Arthur's Knights of the Round Table, but he could find no solace. In Brittany, he met a beautiful maiden with extraordinarily white hands whose name by coincidence was also Isolde (an extremely popular name for the time, apparently.) Tristan married Isolde of the White Hands but never consummated the marriage. Instead he set off to fight a dragon.

The battle, like any mortal combat, was grim, glorious and brutal in its finality. Tristan prevailed, but was badly wounded.

As he lay dying in the seaside castle he shared with Isolde of the White Hands, he sent word to his beloved Isolde, knowing that only she could cure him. He instructed his messenger to hoist white sails above the ship upon its return if Isolde was on board, black sails if she was not. Thus he would know if his one true love would come back to him.

As the ship sailed in, Tristan lay too weak to raise his head. He asked Isolde of the White Hands if the sails were white or black. The big white sails billowed majestically against the crisp blue sky, but his jealous wife replied, “black.” Tristan died of a broken heart.

Upon finding his body, the spirit of his beloved Isolde departed this earth.

Cleopatra's Passion

The story of Antony and Cleopatra

When Cleopatra heard that the strapping red-haired general was waiting for her in her foray, she greeted the news with a smile. She had first met Mark Antony many years before in Egypt, when she was only a child. She had liked him from the start. Now he was one of her only friends in Rome. The two shared one compelling bond: Both were fiercely loyal to her lover, the great Julius Ceasar.

The moment she laid eyes on Antony, her smile faded. His face gave her the grim news before his words. Julius Caesar was dead, murdered by his own council. Cleopatra and her son, Caesarion, were in terrible danger. There was no time to lose. They must get out of Rome immediately.

Cleopatra had married Caesar in Egypt. Though the union was not recognized in Rome, Caesarion was Caesar's only son. A child of three, he would be a threat to those who wanted to rule in Caesar's place as long as he lived. Worse, the Roman populace universally despised his mother. Cleopatra was blamed for Caesar's excessive ambition, his desire to convert Rome from a republic to a monarchy with himself as king and Caesarion as his heir. Some claimed she had bewitched Caesar with African magic.

In truth, Cleopatra was not really African. She was Macedonian (Greek), descended from the man Caesar admired most, Alexander the Great. Though blonde and fair—she wore a dark wig in public as part of her ceremonial headdress—Cleopatra was hardly a classical beauty. But she possessed more than pedigree and wealth. To present herself before Caesar for the first time, she rolled herself up in Persian rug. She managed more than a clever introduction, averting an assassin's knife in process. She was bright, clever, resourceful and—most of all—original. There was little doubt that Caesar truly loved her.

Caesar was a temperate man, a serious thinker and philosopher, a man who walked upon the world stage—and knew it. He was a man who courted history.

He had but one weakness. An epileptic since birth, his seizures grew worse under stress, striking often at the most inopportune times. Caesar was terribly embarrassed by his infirmary, but in Cleopatra he discovered a partner who could nurse him through his illness, shield him from the public eye and even make decisions in his stead. In a sense, his weakness drew them closer, forming an indelible bond of trust.

Antony's response to Cleopatra's danger was probably based as much upon his loyalty to Caesar as anything else. There is no evidence that any relationship beyond friendship existed between Antony and Cleopatra before the assassination of Caesar. Still, Antony was taking a considerable risk. As Caesar's favorite general he would be part of the Triumvirate chosen to rule in Caesar's stead. His alliance with the unpopular Cleopatra would galvanize a score of bitter enemies against him in Rome.

However, in the moments following Caesar's bloody murder, all Antony could think of was getting Cleopatra and young Caesarion out of Rome. Legend has it that Antony disguised himself as a pregnant beggar woman, strapping little Caesarion to his belly. The muscular Antony would have made a rather imposing beggar woman, but the ruse apparently worked. In rags, Antony, Cleopatra and Caesarion were smuggled aboard a mercantile ship, eventually making their way safely back to Egypt.

In the majestic Egyptian capital, Alexandria, the romance of Antony and Cleopatra blossomed. They were married on the Nile, though Antony had not divorced his Roman wife. Of course, Cleopatra needed him for Caesarion, for herself, for the plans she had made with Caesar. He would betray her once, but he would come back. In the end, he would risk everything for her.

Her love for him was as fiery as his red curly hair, and as difficult to control. He drank too much. He enjoyed the company of his soldier friends. The royal couple was known to engage in fierce shouting matches. But they produced three beautiful children: the heavenly twins Cleopatra Selene (the Moon) and Alexander Helios (the Sun) and the baby Ptolemy Philadelphus.

Antony was an intelligent man and a competent general, but he was no Caesar, a fact that weighed upon him and his wife. In truth, both Antony and Cleopatra lived in Caesar's shadow. It would cost them their kingdoms.

In their crucial showdown with Octavian, Antony's brother-in-law and their enemy in Rome, they were at odds about what to do. Cleopatra wanted Antony to lead the attack by sea, giving the glory to Egypt, which possessed an impressive navy. But Antony, primarily a field commander, still owned the loyalty of his old Roman legions. He wanted to be on the ground, leading the charge with his familiar troops.

And he wanted Caesarion to stay at home in Alexandria. Octavian would kill Caesarion at the first opportunity. But Cleopatra's dreams of glory had ignited a fierce passion within her. She wanted Caesarion by her side, and Antony too. She felt a confidence she had not known since Caesar's death.

Of course, Caesar would never have agreed to such a ridiculous plot. Nor would Cleopatra have pressed him so diligently.

The battle began well enough for Egypt, with the ship of Cleopatra and Caesarion leading one flank and Antony's ship leading the other. But the smaller Roman boats soon outmaneuvered the large Egyptian ships. As the battle began to turn, Cleopatra feared for Caesarion. He was 17 now. She had wanted him to experience the glory of his first great victory. Now, she just wanted to get him out of there. She turned her ship to flee, wishing only to protect her son. Inexplicably, Antony followed. From the shore, Antony's loyal troops watched their leader sail away from the raging battle on the tail of the Queen of the Nile. Disheartened, they surrendered to their former compatriots.

Loyalty to Antony could be forgiven, Octavian reassured them, now that they had seen the error of their ways. Soon the united Roman legions were ready to march against Alexandria.

Word was sent to Cleopatra. Egypt stood no chance against the combined Roman forces. Turn Antony over, Octavian wrote. Spare everyone a costly battle. Remain as Queen of Egypt. All that needed to be done was to turn Antony over.

Octavian, soon to be the Emperor Augustus, was not nearly so charmed by Cleopatra as Caesar and Antony had been. But he felt he knew her pretty well. Ambitious, but practical, he knew nothing had come easily to Cleopatra. Her own sister had tried to kill her. She had needed a keen survival instinct to get this far. Surely, she would accept his offer.

By this time, Antony was a ruin of a man. Within days he would fall upon his own sword. But Octavian had underestimated Cleopatra. She would never betray her husband, no matter how hopeless the cause. She smuggled Caesarion out of the country, erroneously believing him to be in safe hands (Ceasarion was murdered by his own tutor). When Antony killed himself, Cleopatra resolved not to be taken back to Rome in chains to be humiliated in front of the venomous crowd. With the help of her clever daughter, Selene, a poisonous cobra was secretly slipped past the guard. Cleopatra put the snake to her throat and died in her bed like a Queen.

Cleopatra's son, Helios, was killed by Octavian. Selene and little Ptolemy were brought to Rome in chains to march in Octavian's triumphal procession.

Sitting in the audience was Juba, a former African prince who himself had been brought to Rome in chains as a child of six. Like most prisoners, Juba was to be sent to the dungeons after the procession, where he would die of starvation or be eaten by rats. But the terrified child had refused to cry and conducted himself with such intelligence and poise that he captured the eye of Octavian, who spared his life. Now age 23, he had become a favorite of the Roman court and a personal friend of the great poet Ovid.

Juba watched the garish display—the armies, the horses, the magnificent wild beasts, the doomed prisoners, the little orphans in chains, dusty tear stained faces, legs giving out. They couldn't take it much longer, he knew.

A trumpet blared, frightening the horse of Tiberius, Octavian's 13-year-old nephew. The horse backed into Ptolemy. Selene screamed, throwing her arms around her brother. Juba sprang from his seat, racing onto the Via Sacra and snatching the small boy into his arms. Then he turned to the sobbing Selene. “I know you're scared,” he said, “but remember who you are.”

Perhaps moved by the scene, or the courage Selene would exhibit from that point on, Octavian spared the lives of Cleopatra's children, raising them in his own house with his own nephews and nieces.

Selene would eventually marry Juba and the two of them would go on to rule a new nation in Africa and built a city of dreams. Their life would be the stuff of legends. But, that's another story.

The foregoing description has been presented for purposes of illustration and description. It is not intended to be exhaustive or to limit the invention to the precise forms disclosed. Obvious modifications or variations are possible in light of the above teachings. The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A method for selling a ring comprising:
providing a display in close proximity with the ring, wherein the display has a defined love story theme associated with it;
providing a first insignia on an inner diameter of a shank of the ring;
providing a second insignia on a portion of the ring that is visible when the ring is positioned on a finger;
delivering the ring in a box, the box containing a miniature book containing at least one love story that is associated with the love story theme; and
providing a presentation folder that is configured for movement between open and closed positions, the folder containing a personalized love note and a certificate of authenticity that are disposed for viewing when the booklet is in the open position.

2. The method as defined in claim 1, wherein the step of providing a second insignia includes providing a heart-shaped insignia.

3. The method as defined in claim 1, wherein the step of providing a display includes providing a framed picture, wherein the picture portrays a scene that is associated with the defined love story theme.

4. The method as defined in claim 1, wherein the step of providing a display includes providing a caption that is logically associated with the defined love story theme.

5. The method as defined in claim 1, wherein the step of providing a display includes providing a quote that is associated with love or romance.

6. The method as defined in claim 1, wherein the ring is a diamond ring.

7. The method as defined in claim 1, wherein the step of providing a second insignia includes providing a red heart on the inner diameter of the shank of the ring.

8. The method as defined in claim 1, wherein the step of providing a second insignia includes providing the words “Love Story” on the inner diameter of the shank of the ring.

9. The method as defined in claim 1, wherein the step of providing a first insignia includes providing a heart shape near the setting of the ring.

10. A jewelry assembly for enhancing the sale of a ring comprising:
a display disposed in close proximity with the ring, wherein the display has a defined love story theme associated with it;
a first insignia disposed on an inner diameter of a shank of the ring;
a second insignia disposed on a portion of the ring that is visible when the ring is positioned on a finger;
a box for holding and storing the ring, the box containing a miniature book containing at least one love story that is associated with the love story theme; and
a presentation folder that is configured for movement between open and closed positions, the presentation folder containing a personalized love note and a certificate of authenticity that are disposed for viewing when the booklet is in the open position.

11. The method as defined in claim 10, wherein the display includes a framed picture, wherein the picture portrays a scene that is associated with the defined love story theme.

12. The jewelry assembly as defined in claim 10, wherein the display includes caption that is logically associated with the defined love story theme.

13. The jewelry assembly as defined in claim 10, wherein the display includes a quote that is associated with love or romance.

14. The jewelry assembly as defined in claim 10, wherein the ring is a diamond ring.

15. The jewelry assembly as defined in claim 10, wherein the second insignia includes a red heart.

16. The jewelry assembly as defined in claim 10, wherein the second insignia includes the words “Love Story”.

17. A method for selling an article of jewelry comprising:
providing a display in close proximity connection with the article of jewelry, wherein the display has a defined love story theme associated with it;
delivering the article of jewelry in a box, the box containing at least one love story that is associated with the love story theme; and
providing a presentation folder containing a personalized love note, the presentation folder further including a graphic image that is associated with the love story theme.

18. The method as defined in claim 17, wherein the article of jewelry is a ring.

19. The method as defined in claim 17, further including the step of providing a heart shape insignia with the article of jewelry.

20. The method as defined in claim 17, further including the step of providing the words “Love Story” on the article of jewelry.
